(19) United States
(12) Patent Application Publication
(10) Pub. No.: US 2026/0182655 A1
(43) Pub. Date: Jul. 2, 2026

(54) AEROSOL GENERATING DEVICE

(71) Applicant: KT&G CORPORATION, Daejeon (KR)

(72) Inventors: Wonkyeong LEE, Daejeon (KR); Hunil Lim, Daejeon (KR); Jinsoo Seong, Daejeon (KR)

(73) Assignee: KT&G CORPORATION, Daejeon (KR)

(21) Appl. No.: 19/333,720

(22) Filed: Sep. 19, 2025

(30) Foreign Application Priority Data
Dec. 30, 2024 (KR) 10-2024-0201176

(51) Int. Cl. A24F 40/465; A24F 40/20; A24F 40/51; A24F 40/57; A24F 40/70

(52) U.S. Cl. CPC A24F 40/465; A24F 40/51; A24F 40/57; A24F 40/70; A24F 40/20

(57) ABSTRACT

An aerosol generating device according to an embodiment includes an insertion space into which at least a portion of an aerosol generating article is inserted, a source unit configured to generate a radio frequency (RF) signal, a power converter configured to generate direct current of various levels, a heater configured to heat the aerosol generating article, and a processor, wherein the processor is further configured to control the power converter and the source unit to operate the heater in a dielectric heating mode in which electromagnetic waves are radiated into the insertion space or a resistance heating mode in which thermal energy is transmitted to the insertion space and to provide the RF signal or the direct current to the heater.

### CROSS-REFERENCE TO RELATED APPLICATION

This application is based on and claims priority under 35 U.S.C. § 119 to Korean Patent Application No. 10-2024-0201176, filed on Dec. 30, 2024, in the Korean Intellectual Property Office, the disclosure of which is incorporated by reference herein in its entirety.

### BACKGROUND

### 1. Field

The disclosure relates to an aerosol generating device, and more particularly, to an aerosol generating device capable of heating an aerosol generating article by radiating radio frequency (RF) signals in the form of electromagnetic waves to the aerosol generating article.

### 2. Description of the Related Art

Recently, the demand for alternative methods to overcome the shortcomings of general cigarettes has increased. For example, there is a growing demand for systems in which aerosols are generated by heating cigarettes or aerosol generating materials by using aerosol generating devices, rather than methods of generating aerosols by burning cigarettes.

Aerosol generating devices employing methods of heating materials through electrical resistance or dielectric heating methods of heating aerosol generating materials using radio frequency (RF) signals in a non-contact manner have been spotlighted.

### SUMMARY

A dielectric heating method in which heat is uniformly generated within a dielectric material has an advantage over a method in which an aerosol generating article is externally heated through electrical resistance in that the aerosol generating article may be uniformly heated.

The dielectric heating method may have some issues, such as high power consumption during the generation of radio frequency (RF) signals and overheating caused by the heat generated in a source unit configured to generate the RF signals.

Therefore, to reduce power consumption of the aerosol generating device and prevent overheating of the source unit or a circuit board on which the source unit is mounted, it is necessary to operate the heater selectively in a resistance heating method or a dielectric heating method as needed.

One or more embodiments provide selectively operating the heater of the aerosol generating device in a dielectric heating mode or a resistance heating mode.

Additional aspects will be set forth in part in the description which follows and, in part, will be apparent from the description, or may be learned by practice of the presented embodiments of the disclosure.

According to an embodiment, an aerosol generating device includes an insertion space into which at least a portion of an aerosol generating article is inserted, a source unit configured to generate a radio frequency (RF) signal, a power converter configured to generate direct current of various levels, a heater configured to heat the aerosol generating article, and a processor, wherein the processor is further configured to control the power converter and the source unit to operate the heater in a dielectric heating mode in which electromagnetic waves are radiated into the insertion space or a resistance heating mode in which thermal energy is transmitted to the insertion space and to provide the RF signal or the direct current to the heater.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an aerosol generating device according to an embodiment;

FIG. 2 is a cross-sectional view of an aerosol generating device according to an embodiment;

FIG. 3 is a schematic diagram of a heater according to an embodiment; FIG. 4 illustrates the heater of FIG. 3 in an unfolded and flat state;

FIGS. 5 and 6 are block diagrams of an aerosol generating device according to an embodiment; and

FIG. 7 is a flowchart illustrating a control operation of an aerosol generating device, according to an embodiment.

### DETAILED DESCRIPTION

Hereinafter, embodiments will be described in detail with reference to the accompanying drawings, and the same or similar components will be assigned the same reference numerals regardless of the reference numerals in the drawings, and the same descriptions thereof will be omitted. With regard to the description of the drawings, like reference numerals may be used to represent like or related elements.

The suffixes “module”, “unit”, “-er”, and “-or” for the components used in the following description are given or used interchangeably by considering only the ease of writing the description, and do not have distinct meanings or roles in themselves. The suffix “module” or “unit,” as used herein, may include a unit implemented as hardware, software, or firmware. For example, the suffix “module” or “unit” may be interchangeably used with the term a “logic”, a “logical block”, a “component”, or a “circuit”. The “module” or “unit” may be an integrally formed component, a minimum unit of the component performing one or more functions, or a part of the minimum unit. For example, the “module” or “unit” may be implemented in the form of an application-specific integrated circuit (ASIC).

In addition, when describing the embodiments of the disclosure, the detailed description of the related known art, which may obscure the subject matter of the embodiments, may be omitted. Also, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one element or component from another element or component.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The singular forms are intended to include the plural forms as well unless the context clearly indicates otherwise.

Various embodiments of the present disclosure may be implemented as software including one or more instructions stored in a storage medium (e.g., a memory) readable by a machine (e.g., an aerosol generating device 1). For example, a processor (e.g., the processor 170) of the machine (e.g., the aerosol generating device 1) may call at least one instruction among one or more instructions stored from the storage medium and execute the at least one instruction. This makes it possible for the machine to be operated to perform at least one function according to the called at least one instruction. Examples of the one or more instructions may include codes created by a compiler, or codes executable by an interpreter. A machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored.

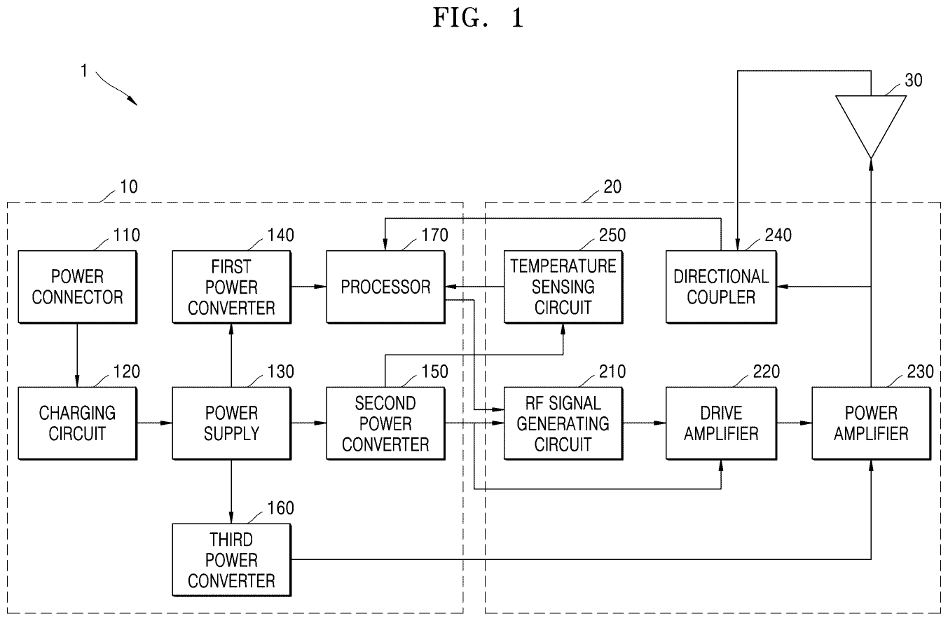

FIG. 1 is a block diagram of an aerosol generating device 1 according to an embodiment.

According to an embodiment, the aerosol generating device 1 may include a control unit 10, a source unit 20, and a radiating unit 30. The control unit 10 may refer to a circuit for controlling the basic operation of the aerosol generating device 1. The source unit 20 may refer to a circuit for generating a radio frequency (RF) signal under the control by the control unit 10. The radiating unit 30 may be a device for radiating an RF signal generated by the source unit 20 in the form of electromagnetic waves into a space into which an aerosol-generating article is inserted (hereinafter, “insertion space”). Charges or ions of a dielectric (e.g., glycerin) included in an aerosol-generating article may vibrate or rotate due to radiated electromagnetic waves (e.g., RF signals), and the aerosol-generating article may be heated as the dielectric generates heat due to frictional heat generated in the process of the charges or ions vibrating or rotating. In other words, the aerosol generating device 1 may be a device that generates an aerosol by heating an aerosol-generating article in a dielectric heating manner.

In an embodiment, the control unit 10 may include a power connector 110, a charging circuit 120, a power supply 130, a first power converter 140, a second power converter 150, a third power converter 160, and/or a processor 170. Additionally, the source unit 20 may include an RF signal generation circuit 210, a drive amplifier 220, a power amplifier 230, a directional coupler 240, and/or a temperature sensing circuit 250. However, it will be understood by those skilled in the art related to the present embodiment that some of the components illustrated in FIG. 1 may be omitted or new components may be added according to the design of the aerosol generating device 1.

The power connector 110 may refer to a physical connection device that is electrically connected to an electronic device or system (e.g., an external power supply) outside the aerosol generating device 1 and used to transmit and receive power. For example, the power connector 110 may receive power from an external power supply and transmit the received power to a component requiring charging (e.g., the power supply 130). The power connector 110 may also provide a path for data transmission. In this case, the power connector 110 may be referred to as a data and power connector. The aerosol generating device 1 may transmit and receive data to or from an external electronic device or system (e.g., a smartphone, a computer, etc.) through the power connector 110. The power connector 110 may include a Universal Serial Bus (USB) power connector, a direct current (DC) power connector, etc. In an example, the power connector 110 may include, but is not limited to, a USB-C type connector capable of supplying 9 V of direct current (DC) voltage at a current of 1 A. The power connector 110 may also include an interface for transmitting and receiving power wirelessly.

The charging circuit 120 may refer to a circuit for charging the power supply 130. The charging circuit 120 may charge the power supply 130 by using power transmitted from the power connector 110. In an example, the charging circuit 120 may be implemented as a charger IC, which is an integrated circuit (IC) that performs functions for efficiently and safely charging the power supply 130. The charging circuit 120 may monitor the charging status of the power supply 130 or optimize the charging process by monitoring the voltage, current, and/or temperature of the power supply 130. For example, the charging circuit 120 may detect the status of the power supply 130 and prevent overcharging or overdischarging by providing an appropriate charging voltage and current.

The power supply 130 may supply power for the operation of the aerosol generating device 1. The power supply 130 may include one or more rechargeable batteries. The power supply 130 may supply power to the radiating unit 30 such that the radiating unit 30 may radiate electromagnetic waves (e.g., RF signals) into the insertion space to heat an aerosol-generating article. Here, power supply to the radiating unit 30 may indicate power supply to the source unit 20. Additionally, the power supply 130 may supply power required for the operation of the processor 170, the RF signal generation circuit 210, the drive amplifier 220, the power amplifier 230, the temperature sensing circuit 250, etc. In an example, the power supply 130 may include, but is not limited to, a lithium polymer (LiPoly) battery. The power supply 130 may be a replaceable type (separated type) battery (hereinafter, a removable battery). The removable battery may be mounted in a battery holder provided within the aerosol generating device 1 or removed from the battery holder. The removable battery may be charged in a wired manner and/or wirelessly.

The aerosol generating device 1 may include a power conversion circuit for converting power supplied from the power supply 130 into power (e.g., voltage and/or current) suitable for other components. The power conversion circuit may include at least one of a buck converter, a buck-boost converter, a boost converter, a Zener diode, and a low-dropout (LDO) regulator. Additionally, the power conversion circuit may include a DC/AC converter (e.g., an inverter) as required.

In an example, the aerosol generating device 1 may include the first power converter 140, the second power converter 150, and the third power converter 160. The first power converter 140 may be an LDO regulator for supplying power (e.g., a DC of 3.3 V) suitable for the processor 170, the second power converter 150 may be a buck-boost converter for supplying power (e.g., a DC of 5 V) suitable for the temperature sensing circuit 250, the RF signal generation circuit 210, and the drive amplifier 220, and the third power converter 160 may be a boost converter for supplying power (e.g., a DC of 12 V/25 W) suitable for the power amplifier 230.

However, the first power converter 140, the second power converter 150, and the third power converter 160 are not limited to the examples described above and may include other types of power conversion circuits. Additionally, although FIG. 1 illustrates the aerosol generating device 1 including three power converters, the aerosol generating device 1 may include more than three power converters or may include fewer power converters. In an example, at least some of the first power converter 140, the second power converter 150, and the third power converter 160 may be integrated into a single power converter.

The processor 170 may control the overall operation of the aerosol generating device 1. For example, the processor 170 may directly or indirectly control charging and discharging of the power supply 130 by using the charging circuit 120. Additionally, the processor 170 may control the voltage and/or current output by a power conversion circuit by controlling the frequency and/or duty ratio of a current pulse input to at least one switching element of the power conversion circuit. In addition to the components described above, the processor 170 may also control the overall operation of other components to be described later.

The processor 170 may be implemented as an array of multiple logic gates, or may be implemented as a combination of a general-purpose microcontroller unit (MCU) (or microprocessor) and a memory storing a program that may be executed in the MCU. Additionally, it will be understood by those skilled in the art that the processor 170 may be implemented in other forms of hardware.

The RF signal generation circuit 210 may generate an RF signal based on power delivered from the power supply 130 or the second power converter 150. An RF signal may refer to a signal having a frequency within a range of about 300 MHz to about 300 GHz. In an example, the RF signal may have a frequency of about 1 GHz to about 100 GHz. Additionally, the RF signal may have a frequency in the Industrial Scientific and Medical equipment (ISM) band, for example, 915 MHz, 2.45 GHz, and/or 5.8 GHz.

The RF signal generation circuit 210 may include a voltage-controlled oscillator (VCO) that generates an RF signal having a different frequency depending on an input voltage. The RF signal generation circuit 210 may receive a control signal (e.g., a DC signal) from the processor 170 and generate an RF signal having a frequency corresponding to the received control signal. The processor 170 may store a control signal corresponding to a desired frequency in the form of a look-up table, or calculate a control signal corresponding to a desired frequency in real time through at least one operation.

In an example, the aerosol generating device 1 may further include a digital to analog converter (D/A converter) for converting a digital control signal output from the processor 170 into an analog control signal. The RF signal generation circuit 210 may receive the analog control signal and generate an RF signal having a frequency corresponding to the received analog control signal.

The drive amplifier 220 may amplify the RF signal generated by the RF signal generation circuit 210. For example, the drive amplifier 220 may provide an input signal suitable for a component of a next stage (e.g., the power amplifier 230) by amplifying the signal level (e.g., amplitude) of the RF signal. The drive amplifier 220 may minimize signal distortion by maintaining high linearity. However, since the drive amplifier 220 is an amplifier focused on increasing the signal level, the drive amplifier 220 may provide relatively low output power.

The power amplifier 230 may amplify power of an RF signal received from the drive amplifier 220. The power amplifier 230 may be an amplifier focused on providing sufficient power to a final output device (e.g., the radiating unit 30). For example, the power amplifier 230 may provide a high-power RF signal to the radiating unit 30 so that the radiating unit 30 may radiate electromagnetic waves into the insertion space to heat an aerosol-generating article. The power amplifier 230 may perform an amplification operation by using power received through the third power converter 160 that provides higher power and/or voltage than the second power converter 150.

The drive amplifier 220 and the power amplifier 230 may include transistors such as a bipolar junction transistor (BJT), a field effect transistor (FET), or a vacuum tube. In an example, the drive amplifier 220 and the power amplifier 230 may be, but are not limited to, gallium nitride (GaN) transistors configured to handle high efficiency, high speed, and high voltage. The drive amplifier 220 and the power amplifier 230 may also include an operational amplifier.

In FIG. 1, the drive amplifier 220 and the power amplifier 230 are illustrated as individual amplifiers, but the drive amplifier 220 and the power amplifier 230 may be integrated into a single amplifier. Additionally, the drive amplifier 220 and/or the power amplifier 230 may be configured as a series connection, a parallel connection, and/or a combination thereof of a plurality of amplifiers.

The radiating unit 30 may include at least one antenna for radiating electromagnetic waves into space. At least one antenna may have a size and shape suitable for the size and shape of an aerosol-generating article. For example, if the aerosol-generating article is cylindrical in shape, at least one antenna may be tubular surrounding the aerosol-generating article that is cylindrical. Here, the shape of the antenna being tubular may indicate that the overall shape of the antenna is tubular. In other words, if the antenna is formed of a metal (e.g., SUS) track, this may indicate that the overall shape of the entire track is tubular. The shape of at least one antenna is not limited to the examples described above and may include various shapes such as a flat plate shape, a curved plate shape, etc.

The radiating unit 30 may heat the aerosol-generating article by radiating electromagnetic waves (e.g., an amplified RF signal or a transmitted RF signal) into the insertion space. For the heating efficiency of the aerosol generating article to be maximized, resonance of electromagnetic waves is to occur within the insertion space. The resonance conditions (e.g., resonant frequency) of the insertion space may vary depending on the amount of dielectric contained in the inserted aerosol-generating article. The processor 170 may control the frequency of an RF signal generated by the RF signal generation circuit 210 to correspond to or be close to the resonance condition of the insertion space by adjusting a control signal input to the RF signal generation circuit 210. The processor 170 may use the directional coupler 240 to obtain information about the resonance conditions of the insertion space.

The directional coupler 240 may refer to a passive element having a waveguide structure that separates an incident wave and a reflected wave from each other. The directional coupler 240 may receive an RF signal transmitted from the power amplifier 230 toward the radiating unit 30 and electromagnetic waves reflected from the insertion space after they are radiated by the radiating unit 30. The directional coupler 240 may separate the transmitted RF signal and the reflected electromagnetic waves, and provide them to the processor 170.

In an example, the aerosol generating device 1 may further include an analog to digital converter (A/D converter) for converting an analog output of the directional coupler 240 into a digital output. The A/D converter may be built into the processor 170 or may exist as a separate component outside the processor 170. The processor 170 may analyze the characteristics (e.g., current, voltage, power, phase, and/or frequency) of the transmitted RF signal and the characteristics (e.g., current, voltage, power, phase, and/or frequency) of the reflected electromagnetic waves by monitoring the output of the directional coupler 240.

The processor 170 may determine whether the operation of the source unit 20 is being performed as intended, based on the characteristics of the transmitted RF signal. Additionally, the characteristics of the transmitted RF signal may be used to determine the heating efficiency of the source unit 20 or the radiating unit 30, together with the characteristics of the reflected electromagnetic wave. The processor 170 may control the source unit 20 such that the heating efficiency of the source unit 20 or the radiating unit 30 is maximized. For example, the processor 170 may adjust the frequency of an RF signal generated by the RF signal generation circuit 210 such that the power of the reflected electromagnetic waves is minimized. Minimizing the power of the reflected electromagnetic waves may indicate that the frequency of the RF signal is closer to the resonance conditions of the insertion space. The characteristics of the transmitted RF signal may provide a criterion for whether the power of the reflected electromagnetic waves is minimized.

Since resonance of electromagnetic waves may occur in the insertion space depending on the frequency of the RF signal, the insertion space may be referred to as a resonant section. At least a portion of the insertion space may be surrounded by at least one shielding member to prevent electromagnetic waves from leaking outside the aerosol generating device 1. In an embodiment, the insertion space may further include a physical structure to ensure that the resonance conditions are within a range controllable by the processor 170. The physical structure may include at least one conductor, and the resonance conditions of the insertion space may vary depending on the arrangement, thickness, and length of the conductor. Additionally, the physical structure may include a space for accommodating a dielectric having low electromagnetic absorption, separate from the dielectric contained in the aerosol-generating article. A dielectric with low electromagnetic absorption may change the resonant frequency of the entire resonant section without absorbing the energy that are to be transferred to the heated material. Accordingly, even if the resonant section is reduced in size, the resonance conditions may be determined within a range controllable by the processor 170.

The temperature sensing circuit 250 may be arranged in contact with or adjacent to components included in the source unit 20 to measure the temperature of the source unit 20. For example, the temperature sensing circuit 250 may be arranged in contact with or adjacent to at least one of the RF signal generation circuit 210, the drive amplifier 220, and the power amplifier 230. Heat may be generated due to limited efficiency in the process of generating and/or amplifying RF signals, and if excessive heat is generated, this heat may have a negative impact on components included in the source unit 20 or other components included in the aerosol generating device 1. The temperature measured by the temperature sensing circuit 250 may be used to prevent overheating of the source unit 20.

The processor 170 may receive the temperature (or a value corresponding to the temperature) measured from the temperature sensing circuit 250, and if it is determined that the source unit 20 is overheated, the processor 70 may stop the operation of the source unit 20. For example, the processor 170 may stop the operation of the source unit 20 by cutting off the power supply to the source unit 20 or transmitting a control signal. Hereinafter, the term ‘power supply’ to the source unit 20 is used to indicate controlling whether the source unit 20 operates.

The temperature sensing circuit 250 may include at least one temperature sensor among a thermocouple, a resistance temperature detector (RTD), a thermistor, a semiconductor temperature sensor, and an optical temperature sensor. In an example, the temperature sensing circuit 250 may be implemented as a chip-type sensor (e.g., a negative temperature coefficient (NTC) sensor) to minimize the area occupied, but is not limited thereto.

The aerosol generating device 1 may include other components in addition to the components illustrated in FIG. 1. For example, the aerosol generating device 1 may further include a sensor unit, an output unit, an input unit, a communication unit, and a memory. In addition, if the aerosol generating device 1 is a hybrid type device that uses both an aerosol-generating article and a cartridge, the aerosol generating device 1 may further include a cartridge heater. The cartridge heater may receive power from the power supply 130 to heat a medium and/or an aerosol-generating material within the cartridge.

According to an embodiment, the sensor unit may detect the status of the aerosol generating device 1 or the status around the aerosol generating device 1 and transmit the detected information to the processor 170. For example, the sensor unit may include a temperature sensor, a puff sensor, an insertion detection sensor, a reuse detection sensor, an overly moist detection sensor, a cigarette identification sensor, a cartridge detection sensor, a cap detection sensor, and/or a motion detection sensor. The sensor unit may further include various sensors, such as a liquid remaining amount sensor for detecting the remaining liquid amount of the cartridge, and an immersion sensor for detecting immersion of the aerosol generating device 1.

In an embodiment, the temperature sensor may detect the temperature of the insertion space or the aerosol-generating article. The temperature sensor may be positioned in contact with or adjacent to the insertion space or the aerosol-generating article to directly measure the temperature of the insertion space or the aerosol-generating article. Additionally, the temperature sensor may be positioned to be spaced apart from the insertion space or the aerosol-generating article to indirectly measure the temperature of the insertion space or the aerosol-generating article (e.g., in a non-contact manner). In an example, the temperature sensor may include an optical temperature sensor (e.g., an infrared temperature sensor).

In an embodiment, the temperature sensor may detect the temperature of the power supply 130. The temperature sensor may be arranged adjacent to the power supply 130. For example, the temperature sensor may be attached to one surface of the power supply 130 (e.g., a battery) and/or mounted on one surface of a printed circuit board. For example, the aerosol generating device 1 may include a protection circuit module (PCM), and the temperature sensor may be positioned adjacent to the power supply 130 together with the PCM.

According to an embodiment, the temperature sensor may be arranged inside the housing (not shown) of the aerosol generating device 1 to detect the temperature inside the housing (not shown).

In an embodiment, the puff sensor may detect a user's puff.

As an example, the puff sensor may include a pressure sensor. The pressure sensor may output a signal corresponding to the internal pressure of the aerosol generating device 1, and the processor 170 may detect a user's puff based on the signal corresponding to the internal pressure. The internal pressure of the aerosol generating device 1 may correspond to pressure of an airflow path on which gas flows. The puff sensor may be disposed to correspond to the airflow path, through which gas flows, in the aerosol generating device 1.

In another example, the puff sensor may include a temperature sensor. When a user puffs, a temporary temperature drop may occur in the airflow path, the insertion space, the aerosol generating article, etc. The processor 170 may detect the user's puff based on a signal corresponding to the temperature of an airflow path, etc. output from a temperature sensor.

In another example, the puff sensor may include both a pressure sensor and a temperature sensor. In this case, the temperature sensor may measure the temperature which is used to correct the internal pressure measured by the pressure sensor. For example, the puff sensor may correct a signal corresponding to internal pressure based on a temperature measured by the temperature sensor and output the corrected signal. In another example, the puff sensor may output a signal corresponding to a temperature measured by the temperature sensor and a signal corresponding to the internal pressure measured by the puff sensor. In this case, the processor 170 may receive the signals and correct the signal corresponding to the internal pressure, based on the signal corresponding to the temperature.

In another example, the puff sensor may include a capacitance-based sensor. In the disclosure, the capacitance-based sensor may also be referred to as a capacitive sensor. When a user puffs, temperature changes and/or aerosol flow may occur within the insertion space, thereby changing the permittivity within the insertion space. The processor 170 may detect the user's puff based on a signal corresponding to the permittivity inside the insertion space output from the capacitive sensor.

The puff sensor is not limited to the examples described above and may be implemented with various sensors to detect the user's puff.

In an embodiment, the insertion detection sensor may detect insertion and/or removal of an aerosol-generating article. The insertion detection sensor may be installed around the insertion space.

As an example, the insertion detection sensor may include a capacitive sensor. The capacitive sensor may include at least one conductor, wherein the at least one conductor may be positioned adjacent to the insertion space. When an aerosol generating article is inserted or removed within the insertion space, the permittivity around the conductor may change. The processor 170 may detect insertion and/or removal of an aerosol-generating article based on a signal corresponding to the permittivity inside the insertion space output from the capacitive sensor.

In another example, the insertion detection sensor may include an inductive sensor. The inductive sensor may include at least one coil, wherein the at least one coil may be positioned adjacent to the insertion space. When an aerosol-generating article (e.g., a wrapper for the aerosol-generating article) contains a conductor, a change in the magnetic field may occur around the current-carrying coil when the aerosol-generating article is inserted into or removed from the insertion space. The processor 170 may detect insertion and/or removal of an aerosol-generating article including a conductor based on characteristics of a current output from or detected by an inductive sensor (e.g., frequency of an alternating current, current value, voltage value, inductance value, impedance value, etc.). Alternatively, the aerosol-generating article (e.g., the medium portion of the aerosol-generating article) may include a susceptor (e.g., SUS). Even in this case, a change in the magnetic field around the coil may occur based on the insertion or removal of a susceptor or the like within the insertion space, and the processor 170 may also detect the insertion and/or removal of the aerosol-generating article based on the characteristics of the current of the inductive sensor.

The insertion detection sensor is not limited to the examples described above and may be implemented using various sensors (e.g., proximity sensors, etc.) for detecting insertion and/or removal of an aerosol-generating article. Additionally, the insertion detection sensor may include any combination of the examples described above. In an embodiment, the insertion detection sensor may include a switch or the like for detecting compression by an aerosol-generating article.

In an embodiment, the reuse detection sensor may detect whether an aerosol-generating article has been reused. As an example, the reuse detection sensor may be a color sensor for detecting the color of the aerosol generating article. When the aerosol-generating article is used by a user, a change in color of a portion of the wrapper surrounding the outside of the aerosol-generating article may occur due to the generated aerosol or heating. The color sensor may output a signal corresponding to optical characteristics (e.g., wavelength of light) corresponding to the color of the wrapper based on light reflected from the wrapper. The processor 170 may determine that the aerosol-generating article inserted into the insertion space has already been used if a change in color of a portion of the wrapper is detected.

In an embodiment, the overly moist detection sensor may detect whether the aerosol-generating article is overly moist. For example, the overly moist detection sensor may include a capacitive sensor. The capacitive sensor may include at least one conductor positioned adjacent to the insertion space. The processor 170 may detect whether the aerosol-generating article is overly moist, based on the level of a signal corresponding to a permittivity or the like output from the capacitive sensor. For example, the processor 170 may determine a level range within which the level of the signal is included, based on a look-up table, and determine the moisture content of the aerosol-generating article based on the determined level range.

In an embodiment, the cigarette identification sensor may detect whether the aerosol-generating article is authentic and/or detect the type of the aerosol-generating article.

As an example, the cigarette identification sensor may include an optical sensor for detecting an identification material (or identification tag) located on an outer surface of an aerosol-generating article (e.g., a wrapper). The optical sensor may irradiate light toward the identification material (or identification mark) of the aerosol-generating article and detect, based on the reflected light, the authenticity and/or type of the aerosol-generating article. For example, the identification material may include a material that emits light of a particular wavelength, based on the irradiated light. The processor 170 may detect whether the aerosol-generating article is authentic and/or the type of the article based on the range of the wavelength.

In another example, the cigarette identification sensor may include a capacitive sensor. Depending on the type of aerosol generating article inserted into the insertion space, the permittivity inside the insertion space may vary. The processor 170 may detect whether the aerosol generating article is authentic and/or the type thereof based on a signal corresponding to the permittivity inside the insertion space output from the capacitive sensor.

In another example, the cigarette identification sensor may include an inductive sensor. When a conductor is included in a wrapper and/or interior (e.g., medium portion) of an aerosol-generating article inserted into the insertion space, the characteristics of the current detected by the inductive sensor (e.g., frequency of AC current, current value, voltage value, inductance value, impedance value, etc.) may differ depending on the type of the aerosol-generating article inserted into the insertion space. The processor 170 may detect whether the inserted aerosol-generating article is authentic and/or the type thereof based on the characteristics of the current output from or detected by the inductive sensor.

The cigarette identification sensor is not limited to the examples described above and may be implemented using various sensors to detect whether the aerosol-generating article is authentic and/or to detect the type of the aerosol-generating article. Additionally, the cigarette identification sensor may include any combination of the examples described above.

In an embodiment, the cartridge detection sensor may detect mounting and/or removal of a cartridge. For example, the cartridge detection sensor may include an inductive sensor, a capacitive sensor, a resistive sensor, a hall sensor (hall IC) and/or an optical sensor.

In an embodiment, the cap detection sensor may detect attachment and/or removal of a cap. For example, the cap detection sensor may include an inductive sensor, a capacitive sensor, a resistive sensor, a contact sensor, a hall sensor (hall IC) and/or an optical sensor. The cap may include a structure that covers at least a portion of a cartridge mounted or inserted into the aerosol generating device 1, or covers at least a portion of the housing of the aerosol generating device 1. The cap detection sensor may output a signal corresponding to the mounting or removal of the cap when the cap is mounted on or removed from the housing, and the processor 170 may detect the mounting or removal of the cap based on the signal corresponding to the mounting or removal.

According to an embodiment, the motion detection sensor may detect movement of the aerosol generating device 1. The motion detection sensor may be implemented using at least one of an acceleration sensor or a gyro sensor.

According to an embodiment, the sensor unit may further include, in addition to the sensors described above, at least one of a humidity sensor, an atmospheric pressure sensor, a magnetic sensor, a position sensor (global positioning system (GPS)), or a proximity sensor. The functions of the sensors would be instinctively understood by one of ordinary skill in the art in view of their names and thus detailed descriptions thereof are omitted herein.

According to an embodiment, the output unit may output information about the status of the aerosol generating device 1. The output unit may include, but is not limited to, a display, a haptic unit, and/or an audio output unit. For example, information about the aerosol generating device 1 may include the charging/discharging status of the power supply 130 of the aerosol generating device 1, the operating status of the source unit 20 or the radiating unit 30, the insertion/removal status of the aerosol-generating article and/or cartridge, the mounting and/or removal status of the cap, or the status in which the use of the aerosol generating device 1 is limited (e.g., detection of an abnormal article). The display may visually provide information to the user about the status of the aerosol generating device 1. For example, the display may include a light-emitting diode (LED) light emitting element, a liquid crystal display (LCD) panel, an organic light-emitting diode (OLED) display panel, etc. The display, if the display includes a touchpad, may also be used as an input device. The haptic unit may provide tactile information to the user about the status of the aerosol generating device 1. For example, the haptic component may include a vibration motor, a piezoelectric element, an electrical stimulation device, and the like. The audio output unit may provide information about the aerosol generating device 1 to the user audibly. For example, the audio output unit may convert an electrical signal into an audio signal and output the same externally.

According to an embodiment, the input unit may receive information input from a user. For example, the input unit may include a touch panel, a button, a key pad, a dome switch, a jog wheel, a jog switch, and the like.

According to an embodiment, the memory may be hardware that stores various data processed within the aerosol generating device 1, and may store data processed by the processor 170 and data to be processed. For example, the memory may include at least one type of storage medium among a flash memory type, a hard disk type, a multimedia card micro type, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. For example, the memory may store data about the operation time of the aerosol generating device 1, the maximum number of puffs, the current number of puffs, at least one temperature profile, and the user's smoking pattern.

According to an embodiment, the communication unit may include at least one component for communicating with another electronic device (e.g., a portable electronic device). For example, the communication unit may include a Bluetooth communication unit, a Bluetooth Low Energy (BLE) communication unit, a near field Communication unit, a wireless local area network (WLAN) communication unit, a Zigbee communication unit, an infrared (Infrared Data Association (IrDA)) communication unit, a wireless fidelity direct (WFD) communication unit, a ultra-wideband (UWB) communication unit, an Adaptive Network Topology (ANT)+ communication unit, a cellular network communication unit, an Internet communication unit, a computer network (e.g., LAN or WAN) communication unit, etc.

According to an embodiment, the processor 170 may control the temperature of the insertion space or the aerosol-generating article by controlling an amplification factor of the source unit 20 (e.g., the power amplifier 230). The processor 170 may control the amplification factor of the source unit 20 (e.g., the power amplifier 230) based on the temperature of the insertion space or the aerosol-generating article detected using the temperature sensor. The processor 170 may control the amplification factor of the source unit 20 (e.g., the power amplifier 230) based on the temperature profile and/or power profile stored in the memory.

Additionally, the processor 170 may control the temperature of the cartridge heater by controlling the supply of power from the power supply 130 to the cartridge heater. The processor 170 may control the temperature of the cartridge heater and/or power supplied to the cartridge heater, based on the temperature of the cartridge heater detected using the temperature sensor. The processor 170 may control the temperature of the cartridge heater and/or the power supplied to the cartridge heater based on the temperature profile and/or power profile stored in the memory.

In an embodiment, the processor 170 may prevent the insertion space, the aerosol-generating article, and/or the cartridge heater from overheating. For example, the processor 170 may control the operation of the power conversion circuit to reduce the amount of power supplied to the source unit 20 or the cartridge heater, or to stop supplying power to the source unit 20 or the cartridge heater, based on a determination that temperature of the insertion space, the aerosol-generating article, and/or the cartridge heater exceeds a preset threshold temperature.

According to an embodiment, the processor 170 may control power supply to the source unit 20 or the cartridge heater, based on a result detected by the sensor unit.

In an embodiment, the processor 170 may control power supply to the source unit 20 or the cartridge heater based on insertion and/or removal of the aerosol-generating article into the insertion space. For example, the processor 170 may control power to be supplied to the source unit 20 or the cartridge heater when it is determined that the aerosol-generating article has been inserted into the insertion space using the insertion detection sensor. The processor 170 may cut off the power supply to the source unit 20 or the cartridge heater if it is determined that the aerosol-generating article has been removed from the insertion space using the insertion detection sensor. The processor 170 may determine that the aerosol-generating article has been removed from the insertion space, if the temperature of the insertion space or the aerosol-generating article is above a limited temperature or if the temperature change gradient of the insertion space or the aerosol-generating article is equal to or above a set gradient.

In an embodiment, the processor 170 may control the power supply time and/or power supply amount of power supplied to the source unit 20 or the cartridge heater, based on the state of the aerosol-generating article. For example, the processor 170 may increase the power supply time (e.g., preheating time) of power supply to the source unit 20 or the cartridge heater, if it is determined that the aerosol-generating article is in an overly moist state by using the overly moist detection sensor.

In an embodiment, the processor 170 may control power supply to the source unit 20 or the cartridge heater based on whether the aerosol-generating article is to be reused. For example, the processor 170 may cut off power supply to the source unit 20 or the cartridge heater if it is determined that the aerosol-generating article has been used.

In an embodiment, the processor 170 may control power supply to the source unit 20 or the cartridge heater, based on whether the cartridge is engaged and/or removed. For example, the processor 170 may stop supplying power to the source unit 20 or the cartridge heater or control power not to be supplied to the source unit 20 or the cartridge heater if it is determined, by using the cartridge detection sensor, that the cartridge is removed.

In an embodiment, the processor 170 may control power supply to the source unit 20 or the cartridge heater based on whether the aerosol-generating material in the cartridge has been exhausted. For example, the processor 170 may determine that the aerosol-generating material in the cartridge is exhausted if it is determined that the temperature of the cartridge heater exceeds a limit temperature while preheating the cartridge heater (i.e., during the preheating period). If it is determined that the aerosol-generating material in the cartridge has been exhausted, the processor 170 may cut off the supply of power to the source unit 20 or the cartridge heater.

In an embodiment, the processor 170 may control power supply to the source unit 20 or the cartridge heater based on the availability of the cartridge. For example, the processor 170 may determine that the cartridge is no longer usable if it is determined that the current number of puffs is equal to or greater than the maximum number of puffs set for the cartridge based on data stored in the memory. Alternatively, the processor 170 may determine that the cartridge is unusable if the total time that the cartridge heater has been heated is equal to or greater than a preset maximum time or the total amount of power supplied to the cartridge heater is equal to or greater than a preset maximum amount of power. In this case, the processor 170 may stop supplying power to the source unit 20 or the cartridge heater or control power not to be supplied to the source unit 20 or the cartridge heater.

In an embodiment, the processor 170 may control power supply to the source unit 20 or the cartridge heater based on the user's puff. For example, the processor 170 may use a puff sensor to determine whether a puff has occurred and/or the intensity of the puff. The processor 170 may cut off the power supply to the source unit 20 or the cartridge heater if the number of puffs reaches a preset maximum number of puffs and/or if no puffs are detected for a preset period of time. The processor 170 may also control the supply of power to the source unit 20 or the cartridge heater when a puff is detected.

In an embodiment, the processor 170 may control power supply to the source unit 20 or the cartridge heater based on the authenticity and/or type of the aerosol-generating article (or the cartridge). For example, the processor 170 may use the cigarette identification sensor to detect the authenticity and/or type of the aerosol-generating article (or the cartridge). For example, the processor 170 may cut off power supply to the source unit 20 or the cartridge heater if the aerosol-generating article (or the cartridge) is detected to be counterfeit. The processor 170 may control (e.g., initiate) the supply of power to the source unit 20 or the cartridge heater when the aerosol-generating article (or the cartridge) is detected to be authentic. In another example, the processor 170 may control power supply to the source unit 20 or the cartridge heater differently depending on the type of the aerosol-generating article (or the cartridge). The processor 170 may control the amplification factor of the source unit 20 or the temperature and/or power of the cartridge heater, based on a first temperature profile (or a first power profile) when the aerosol-generating article (or the cartridge) is detected to be a first aerosol-generating article (or a first cartridge), and may control the amplification factor of the source unit 20 or the temperature and/or power of the cartridge heater, based on a second temperature profile (or a second power profile) when the aerosol-generating article (or the cartridge) is detected to be a second aerosol-generating article (or a second cartridge).

According to an embodiment, the processor 170 may control the output unit based on a result detected by the sensor unit. For example, the processor 170 may control the output unit to provide visual, tactile and/or auditory information indicating that the aerosol generating device 1 is about to be terminated, when the number of puffs counted using the puff sensor reaches a preset number. For example, the processor 170 may control the output unit to provide visual, tactile and/or auditory information about the temperature of the insertion space, the aerosol-generating article, or the cartridge heater.

According to an embodiment, the processor 170 may store and update a history of events that occurred in the memory based on the occurrence of a given event. For example, the event may include operations such as detection of insertion of an aerosol-generating article, initiation of heating of an aerosol-generating article, detection of a puff, termination of a puff, detection of overheating, detection of overvoltage application to a cartridge heater, termination of heating of an aerosol-generating article, turning on/off power of the aerosol generating device 1, initiation of charging of the power supply 130, detection of overcharge of the power supply 130, termination of charging of the power supply 130, etc., performed in the aerosol generating device 1. For example, the history of events may include the time an event occurred, log data corresponding to the event, etc. For example, if a given event is detection of insertion of an aerosol-generating article, log data corresponding to the event may include data about sensing values of an insertion detection sensor, etc. For example, if a given event is overheating detection of a cartridge heater, log data corresponding to the event may include data about a temperature of the cartridge heater, a voltage applied to the cartridge heater, a current flowing through the cartridge heater, etc.

According to an embodiment, the processor 170 may control the communication unit to form a communication link with an external device, such as a user's mobile terminal.

According to an embodiment, the processor 170 may release a restriction on the use of at least one function (e.g., a heating function) of the aerosol generating device 1 when data regarding authentication is received from an external device via a communications link. For example, data regarding authentication may include the user's date of birth, a unique number that identifies the user, whether the user has completed authentication, etc.

According to an embodiment, the processor 170 may transmit data about the status of the aerosol generating device 1 to an external device via a communication link (e.g., remaining capacity of the power supply 130, operating mode, etc.). The transmitted data may be output through a display of an external device, etc.

According to an embodiment, when a request for location search of the aerosol generating device 1 is received from an external device via a communication link, the processor 170 may control the output unit to perform an operation corresponding to the location search. For example, the processor 170 may control the haptic unit to generate vibration or control the display to output an object corresponding to the location search and search termination.

According to an embodiment, the processor 170 may perform a firmware update when firmware data is received from an external device via a communication link.

According to an embodiment, the processor 170 may transmit data on sensed values of at least one sensor unit to an external server (not shown) via a communication link, and receive and store a learning model generated by learning the sensed values through machine learning, such as deep learning, from the server. The processor 170 may perform operations such as determining a user's inhalation pattern and generating a temperature profile using a learning model received from a server.

Although not illustrated in FIG. 1, the aerosol generating device 1 may further include a power protection circuit. The power protection circuit may include at least one switching element and may cut off the current path to the power supply 130 in response to overcharge and/or overdischarge of the power supply 130.

An aerosol-generating article as described herein may include at least one aerosol-generating rod (e.g., a medium portion) and at least one filter rod. The radiating unit 30 may be arranged to correspond to at least one aerosol-generating rod, and may be designed differently depending on the arrangement order and/or position of the aerosol-generating rod and the filter rod. The aerosol-generating rod may include at least one of nicotine, an aerosol-generating material, and an additive. For example, the aerosol-generating material may include glycerin (e.g., vegetable glycerin (VG)) and/or propylene glycol (PG), and may also include various other materials. For example, the additive may include flavoring agents and/or organic acids, and may also include various other substances. For example, the aerosol-generating rod may include an aerosol-generating substrate (e.g., a sheet) impregnated with a liquid non-tobacco material (e.g., an aerosol-generating material and/or nicotine), and/or may include a solid tobacco material (e.g., leaf tobacco, reconstituted tobacco, etc.). The tobacco material may be included in the aerosol-generating rod in various forms, such as cut tobacco, granules, or powder. In an embodiment, the additive of the aerosol-generating rod may include a basic substance. Based on the basic material, the nicotine of the tobacco material included in the aerosol-generating rod may have an alkaline pH (e.g., pH 7.0 or higher). In this case, freebase nicotine may be released from the aerosol-generating rod even at low temperatures. According to an embodiment, the aerosol-generating rod may include two or more aerosol-generating rods, wherein the two or more aerosol-generating rods may each include tobacco material and/or non-tobacco material. Although not shown, at least one aerosol-generating rod and at least one filter rod may be individually and/or integrally wrapped by at least one wrapper. In the disclosure, the aerosol-generating article may be referred to as a stick.

The cartridge referred to in the disclosure may include an aerosol-generating material having any one of a liquid state, a solid state, a gaseous state, or a gel state therein. The aerosol-generating material may include a liquid composition. For example, the liquid composition may be a liquid including a tobacco-containing material including a volatile tobacco flavor component, or may be a liquid including a non-tobacco material. The cartridge may include a storage portion containing an aerosol-generating material and/or a liquid transfer means impregnated with (containing) the aerosol-generating material. For example, the liquid transfer medium may include a wick such as cotton fibers, ceramic fibers, glass fibers, porous ceramics, etc. The cartridge heater may be included in the cartridge in the form of a coil surrounding (or winding) the liquid transfer means or in a structure contacting one side of the liquid transfer means. Alternatively, the cartridge heater may be included in the aerosol generating device 1 that is separable from the cartridge.

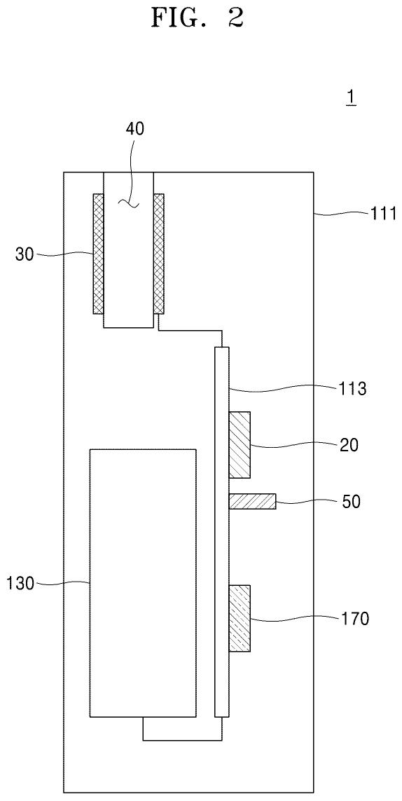

FIG. 2 is a cross-sectional view of the aerosol generating device 1 according to an embodiment.

The aerosol generating device 1 (e.g., the aerosol generating device 1 of FIG. 1) according to an embodiment may include a housing 111, a circuit substrate 113, a source unit 20, a heater 30, a power converter 50, a power supply 130 (e.g., the power supply 130 of FIG. 1), and a processor 170. However, FIG. 2 illustrates only the components required for describing the present embodiment, and the components of the aerosol generating device 1 are not limited thereto. According to an embodiment, some of the components may be omitted, or other components may be added.

The housing 111 may include the insertion space 40 for accommodating or inserting at least a portion of the aerosol generating article and may form an overall exterior of the aerosol generating device 1. Components of the aerosol generating device 1 may be arranged in an inner space of the housing 111.

For example, the circuit substrate 113, the heater 30, the power converter 50, and the power supply 130 may be arranged in the inner space of the housing 111. However, the components of the aerosol generating device 1 arranged in the inner space of the housing 111 are not limited thereto. As another example, a temperature sensing circuit (e.g., the temperature sensing circuit 250 of FIG. 1) for measuring the temperature of the circuit substrate 113 or the source unit 20 may be further arranged in the inner space of the housing 111.

The circuit substrate 113 may be configured to generate a radio frequency (RF) signal. The source unit 20 and the processor 170 may be mounted on the circuit substrate 113. Accordingly, as power is supplied, the circuit substrate 113 may generate an RF signal. However, circuits included in the circuit substrate 113 are not limited thereto.

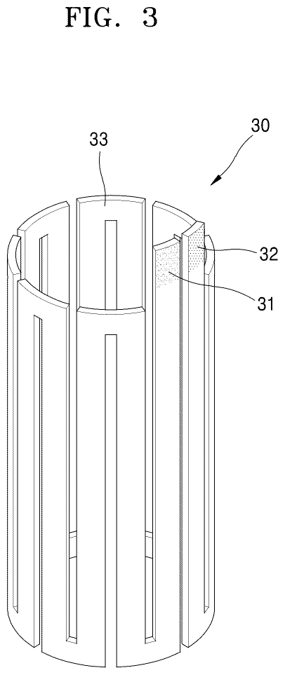

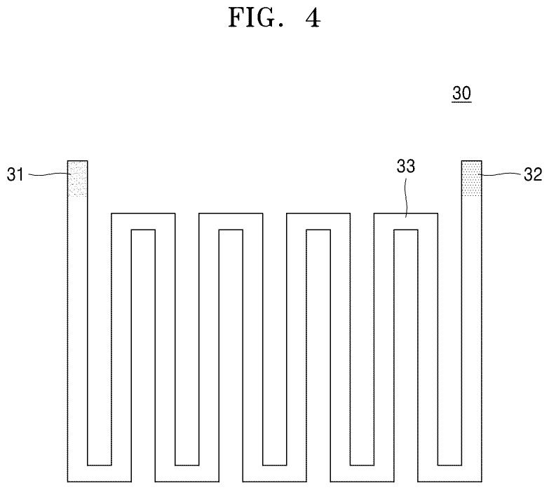

The heater 30 according to an embodiment may operate in a dielectric heating mode of radiating an electromagnetic wave into the insertion space 40 or a resistance heating mode of delivering thermal energy into the insertion space 40. The heater 30 may be arranged to surround the outer circumferential surface of the insertion space 40 and radiate an electromagnetic wave to the aerosol generating article inserted into the insertion space 40. The structure of the heater 30 is described in more detail with reference to FIGS. 3 and 4.

First, the resistance heating mode of the heater 30 is described. The heater 30 may be electrically or operatively connected to the circuit substrate 113 and may generate thermal energy through resistive heating by receiving a direct current from the power converter 50. The power converter 50 may include a DC-DC converter and convert an input voltage into a variable output voltage. The power converter 50 may generate direct current of various levels and provide the same to the heater 30.

Next, the operation of the heater 30 in the dielectric heating mode is described. The heater 30 may radiate, in the form of an electromagnetic wave, an RF signal generated in the source unit 20 to the aerosol generating article inserted into the insertion space 40. The heater 30 may have the same configuration as the radiating unit 30 described in FIG. 1 in that the heater 30 radiates an electromagnetic wave in the dielectric heating mode. The heater 30 may be electrically or operatively connected to the circuit board 113 and radiate an electromagnetic wave (e.g., microwaves) into the insertion space 40 in response to the RF signal provided from the source unit 20.

The vibration or rotation of charges or ions of a dielectric (e.g., glycerin) contained in the aerosol generating article, which is caused by the radiated electromagnetic wave, may generate frictional heat from the dielectric, and the frictional heat may heat the aerosol generating article; thus, an aerosol may be generated. For example, as the vapor generated after the heating of the aerosol generating article is mixed with external air flowing into the gap between the insertion space 40 and the aerosol generating article or the insertion space 40 through an airflow passage (not shown), an aerosol may be generated.

A dielectric heating method in which heat is uniformly generated within a dielectric material has an advantage over a method in which an aerosol generating article is externally heated through electrical resistance in that an aerosol generating article may be uniformly heated.

The dielectric heating method may have some issues, such as high power consumption during the generation of radio frequency (RF) signals and overheating caused by the heat generated in the source unit 20 configured to generate RF signals. Specifically, the source unit 20 for generating an RF signal may consume a considerable amount of power and generate a substantial amount of heat during the operation. When the heat generated by the source unit 20 for generating an RF signal is excessively accumulated within the aerosol generating device 1, performance degradation of the aerosol generating device 1, damage to the components of the aerosol generating device 1, and user safety issues may arise. To overcome the aforementioned issues, it is necessary to prepare an overheating prevention medium for the source unit 20 for generating an RF signal or the circuit substrate 113 on which the source unit 20 is mounted.

As described, to reduce unnecessary power consumption of the aerosol generating device 1 and prevent overheating of the source unit 20 or the circuit substrate 113 on which the source unit 20 is mounted, the heater 30 needs to operate either in a resistance heating mode or a dielectric heating mode according to necessity.

The processor 170 may selectively operate the heater 30 in the dielectric heating mode or the resistance heating mode. The processor 170 may control the power converter 50 to apply a direct current to the heater 30 in the resistance heating mode and control the source unit 20 to apply an RF signal to the heater 30 in the dielectric heating mode.

The processor 170 may adjust the heating mode of the heater 30 in stages during a preheating section and a smoking section. In addition, the processor 170 may adjust the heating mode of the heater 30 in stages to prevent overheating of the source unit 20 or the circuit substrate 113 on which the source unit 113 is mounted.

FIG. 3 is a schematic diagram of the heater 30 according to an embodiment, and FIG. 4 illustrates the heater 30 in an unfolded and flat state.

Referring to FIGS. 3 and 4, the heater 30 may include a metal material. The heater 30 may include an alloy including at least one of a nickel-iron alloy and a constantan alloy. The heater 30 may include a hollow formed to accommodate a portion of the aerosol generating article. The heater 30 may have a cylindrical shape to surround the aerosol generating article inserted into the hollow. Specifically, the heater 30 may be formed by rolling a metal pattern 33 with repeated “S” or “ [symbol] ” shapes into a cylindrical form. The metal pattern 33 may have any of various shapes, such as an angular shape, a curved shape, a mesh shape, or an atypical shape. The heater 30 may include the metal pattern 33, in which one end may be connected to a first terminal 31 and the other end may be connected to a second terminal 32. The resistance of a nickel-iron alloy in the metal pattern 33 may be in a range of about 45 μΩ·cm to about 85 μΩ·cm, and the resistivity may vary depending on changes in composition. For example, the resistivity may be about 60 μΩ·cm when the nickel content is about 40 % and may be about 45 μΩ·cm when the nickel content is about 48 %. The principal components of the constantan alloy are about 55% copper and about 45% nickel, and the resistivity thereof is about 48 μΩ·cm.

The heater 30 may operate as a closed circuit in the resistance heating mode. In detail, the power converter 50 may be connected to the first terminal 31 and the second terminal 32 of the heater 30 to operate the heater 30 in the resistance heating mode. In the resistance heating mode, the heater 30 may function as a closed circuit in which the first terminal 31 and the second terminal 32 are connected to the power converter 50. Because the heater 30 operates as a closed circuit in the resistance heating mode, a direct current may flow through the heater 30. Because the heater 30 includes the metal pattern 33 with repeated “S” or “ [symbol] ” shapes, the length of the metal pattern 33 is much greater than that of a straight metal pattern. Therefore, because the metal pattern 33 of the heater 30 has a significantly greater resistance value than the straight metal pattern, the metal pattern 33 may resistively generate heat sufficient enough to provide thermal energy required to vaporize the aerosol generating article when a direct current is applied. When the heater 30 operates in the resistance heating mode, a direct current flows through the heater 30 so that no electromagnetic wave is radiated.

It may be advantageous for the heater 30 to function as an open-type antenna in the dielectric heating mode. In the dielectric heating mode, the heater 30 may receive an RF signal having a frequency in an Industrial Scientific and Medical (ISM) band, for example, a frequency of about 915 MHz, 2.45 GHz, and/or 5.8 GHz, and a closed-type antenna is not suitable for radiating an RF signal having a relatively high frequency. Examples of closed-type antennas include loop antennas and slot antennas, and for example, a loop antenna has a ring shape in which a conductor forms a closed loop. In a loop antenna, current flows along a closed path. At low frequencies (e.g., AM radio frequency band), the wavelength of the current is long, so sufficient radiation may be achieved even with a closed structure. However, at high frequencies (e.g., RF signals), efficient radiation may not be achieved with a closed structure.

In the dielectric heating mode, to operate as an open-type antenna, the heater 30 may receive an RF signal from the source unit 20 through any one of the first terminal 31 and the second terminal 32, and the other terminal may be open. In the dielectric heating mode, the heater 30 may receive an RF signal from the source unit 20 only through any one of the first terminal 31 and the second terminal 32, and the other terminal may be open; thus, the heater 30 may operate as an open-type antenna.

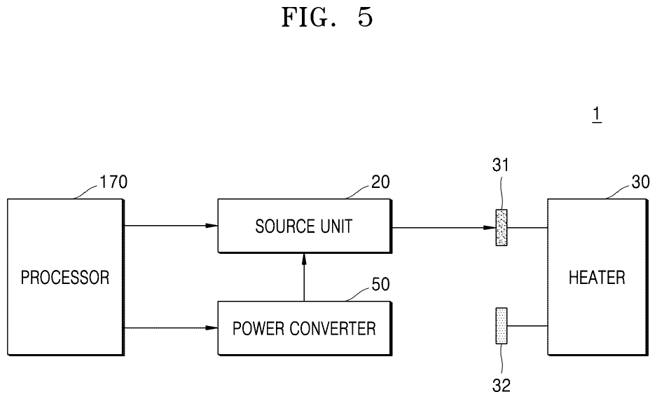

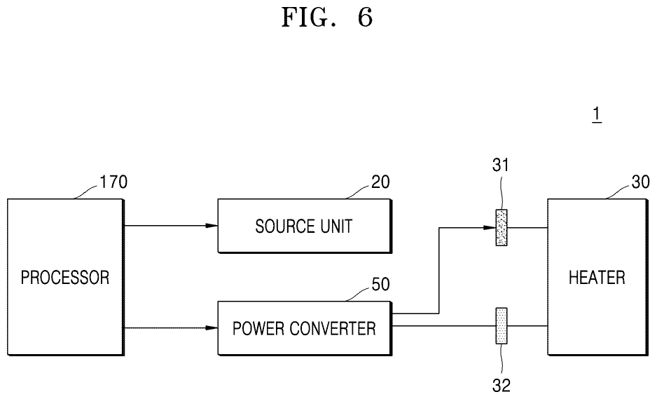

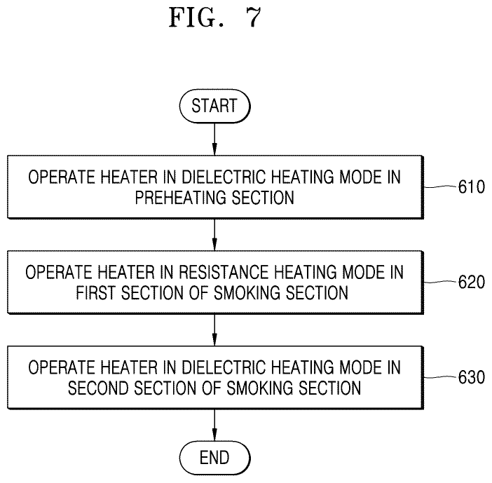

FIGS. 5 and 6 are block diagrams of the aerosol generating device 1 according to an embodiment, and FIG. 7 is a flowchart of a control operation of the aerosol generating device 1, according to an embodiment. FIG. 5 is a block diagram of the aerosol generating device 1 operating in a dielectric heating mode, and FIG. 6 is a block diagram of the aerosol generating device 1 operating in a resistance heating mode.

The aerosol generating device 1 according to an embodiment includes the processor 170, the source unit 20, the power converter 50, and the heater 30.

The power converter 50 may include a DC-DC converter and convert an input voltage to a variable output voltage. The power converter 50 may generate direct current of various levels and provide the same to the heater 30. The power converter 50 may be configured as a combination of the first power converter 50, the second power converter 50, and the third power converter 50 described above with reference to FIG. 1, and repeated descriptions are omitted hereinafter.

The processor 170 may control the heater 30 to receive an RF signal or a direct current and may operate the heater 30 in a dielectric heating mode in which electromagnetic waves are radiated into the insertion space or a resistance heating mode in which thermal energy is transmitted to the insertion space.

The first terminal 31 and the second terminal 32 of the heater 30 may be connected to a switch (not shown) that selectively connects the heater 30 to the power converter 50 or the source unit 20. The processor 170 may control ON/OFF states of the switch to establish an electrical connection between the heater 30 and the power converter 50 or between the heater 30 and the source unit 20, thereby operating the heater 30 in the dielectric heating mode or the resistance heating mode.

The aerosol generating device 1 may preheat the aerosol generating article before the user performs a smoking operation including puffs. The preheating section may correspond to a period during which the user prepares to use the aerosol generating device 1 before the smoking operation is executed using the aerosol generating device 1. The aerosol generating device 1 may perform a preheating operation of the heater 30 according to a preheating profile, and when the preheating profile ends, a notification indicating that the preheating has been completed may be sent. When the preheating profile terminates, the aerosol generating device 1 may perform a heating operation of the heater 30 according to a smoking profile. The smoking section may correspond to a period during which a smoking operation using the aerosol generating device 1 is actually executed. The user may identify that the smoking preparation has been completed through the notification and may execute the smoking operation including puffs during the smoking section.

In an embodiment, the processor 170 may adjust the heating mode of the heater 30 in stages during the preheating section and the smoking section.

First, in operation 610, the processor 170 may operate the heater 30 in the dielectric heating mode during the preheating section. In the dielectric heating mode, because heat is generated from the inside of the aerosol generating material, the initial heating speed may be relatively fast, and the preheating period may be reduced. In addition, the inside of the aerosol generating article may be uniformly heated. Accordingly, a sufficient amount of aerosol may be delivered from a first puff of the user. FIG. 5 illustrates that the heater 30 operating in the dielectric heating mode receives an RF signal from the source unit 20 through the first terminal 31 and the second terminal 32 is open.

In operation 620, the processor 170 may operate the heater 30 in the resistance heating mode during a first section of the smoking section, and in operation 630, the processor 170 may operate the heater 30 in the dielectric heating mode during a second section after the first section.

In the first section that is an initial smoking section, the resistance heating mode may consume relatively less energy than the dielectric heating mode. Because the inside of the aerosol generating article is sufficiently heated in the preheating section, it may be advantageous to quickly heat the outside of the aerosol generating article in the resistance heating mode in which a relatively low amount of energy is consumed during the first section that is the initial smoking section. Because an aerosol is immediately generated as the surface of the aerosol generating article is quickly heated in the resistance heating mode, a sufficient amount of aerosol may be immediately provided to the user. FIG. 6 illustrates that the heater 30 operating in the resistance heating mode receives a direct current from the power converter 50 through the first terminal 31 and the second terminal 32. In this case, the heater 30 operates as a closed circuit.

In the second section that is a later smoking section, the heater 30 may operate in the dielectric heating mode, and a sufficient amount of aerosol may be delivered to the user. By uniformly heating an aerosol generating material remaining in the aerosol generating article in the dielectric heating mode, an aerosol may be efficiently generated. In other words, even after the outer region of the aerosol generating article is mostly vaporized through resistive heating in the initial smoking section, the aerosol yield may be increased by efficiently vaporizing the aerosol generating material remaining in the aerosol generating article through dielectric heating in the later smoking section.

In the aerosol generating device 1 according to an embodiment, the aerosol generating article may be quickly heated in the dielectric heating mode in the preheating section, and then the mode of the aerosol generating device 1 may sequentially switch between the resistance heating mode and the dielectric heating mode; thus, an aerosol may be generated. To this end, the aerosol generating material in the aerosol generating article may be uniformly heated, and as the dielectric heating mode of the aerosol generating device, in which a relatively large amount of power is consumed, may be executed to the minimum extent so that power consumption may be reduced.

In another embodiment, the aerosol generating device 1 may switch the mode of the heater 30 to the resistance heating mode to operate the heater 30 so as to prevent overheating of the source unit 20 or the circuit board on which the source unit 20 is mounted.

For example, the processor 170 may switch the operation mode of the heater 30 in a hysteresis control manner. When the temperature of the source unit 20 becomes higher than a first threshold temperature, the processor 170 may operate the heater 30 in the resistance heating mode to suppress the heating of the source unit 20, and when the temperature of the source unit 20 becomes lower than a second threshold temperature that is lower than the first threshold temperature, the processor 170 may operate the heater 30 in the dielectric heating mode. The processor 170 may switch the mode of the heater 30 to a hysteresis manner to prevent frequent switching of the mode of the heater 30 (that is, frequent ON/OFF operations of the switch connected to the first terminal and the second terminal of the heater 30) and to maintain operational stability of the aerosol generating device 1. Because the processor 170 may receive information regarding the temperature of the source unit 20 from a temperature sensing circuit that is arranged adjacent to the source unit 20 and measures the temperature of the source unit 20.

As another example, the processor 170 may determine a resonance frequency at which the power of reflected electromagnetic waves is minimized in a dielectric heating mode, and when the resonance frequency is greater than a threshold value, the processor 170 may operate the heater 30 in a resistance heating mode. For example, the processor 170 may adjust the frequency of the RF signal generated by the source unit 20 to minimize the power of the reflected electromagnetic waves. Reducing the power of the reflected electromagnetic waves may indicate that the frequency of the RF signal approaches the resonance condition of the insertion space. The characteristics of a transmitted RF signal may provide a criterion regarding whether the power of the reflected electromagnetic waves has been reduced. In addition, the processor 170 may adjust the frequency of the RF signal, which is generated by the source unit 20, to match the resonance frequency to increase the dielectric heating efficiency, and as the frequency of the RF signal output from the source unit 20 increases, current leakage and loss within the circuit forming the source unit 20 may also increase such that the amount of heat generated by the source unit 20 may increase. A high-frequency signal incurs significant switching loss, which may increase the heating of the source unit 20. In consideration of the heat generated by the source unit 20, it is impossible to increase the frequency of the RF signal. As a result, because the resonance condition may not be satisfied, the dielectric heating efficiency may remain low. In this case, switching the operation mode of the heater 30 to the resistance heating mode may be an advantageous alternative for improving power efficiency.

As another example, when the power conversion efficiency of the source unit 20 fails to reach the threshold value, the processor 170 may operate the heater 30 in a resistance heating mode. The power conversion efficiency of the source unit 20 may be calculated by dividing the amount of power of the RF signal, which is transmitted by the source unit 20 to the radiating unit 30, by the amount of power provided to the source unit 20. When the power conversion efficiency of the source unit 20 is low, part of the power that is lost during power conversion may be converted into heat. That is, low power conversion efficiency may increase the heating of the source unit 20. When the power conversion efficiency of the source unit 20 is low, the amount of heat generated by the source unit 20 may increase, and because such an increase is not advantageous in terms of power efficiency, it may be desirable to switch the operation mode of the heater 30 to the resistance heating mode. The processor 170 may monitor the output from the directional coupler (e.g., the directional coupler 240 of FIG. 1) and thus analyze the characteristics (e.g., current, voltage, power, phase, and/or frequency) of the transmitted RF signal and the characteristics (e.g., current, voltage, power, phase, and/or frequency) of the reflected electromagnetic waves.

As described above, the aerosol generating device 1 according to an embodiment may operate the heater 30 for heating the aerosol generating article in the dielectric heating mode or the resistance heating mode.

Referring to FIGS. 1 to 7, the aerosol generating device 1 according to an embodiment includes the insertion space 40 into which at least a portion of the aerosol generating article is inserted, the source unit 20 that generates an RF current, the power converter 50 that generates direct current of various levels, the heater 30 that heats the aerosol generating article, and the processor 170. The processor 170 controls the power converter 50 and the source unit 20 to operate the heater 30 in the dielectric heating mode in which electromagnetic waves are radiated into the insertion space or the resistance heating mode in which thermal energy is transmitted to the insertion space and to provide an RF signal or a direct current to the heater 30.

The heater 30 is formed by rolling the metal pattern 33 with repeated “S” or “ [symbol] ” shapes into a cylindrical form.

The heater 30 includes at least one of a nickel-iron alloy and a constantan alloy.

The processor 170 controls the power converter 50 to apply a direct current to the heater 30 in the resistance heating mode.

The heater 30 operates as a closed circuit in the resistance heating mode.

The processor 170 controls the source unit 20 to apply an RF signal to the heater 30 in the dielectric heating mode.

The heater 30 operating in the dielectric heating mode operates as an open-type circuit.

The processor 170 operates the heater 30 in the dielectric heating mode in the preheating section.

The processor 170 operates the heater 30 in the resistance heating mode in the first section of the smoking section and operates the heater 30 in the dielectric heating mode in a second section after the first section.

The aerosol generating device 1 further includes the temperature sensing circuit 250 that is arranged adjacent to the source unit 20 and measures the temperature of the source unit 20, and the processor 170 operates the heater 30 in the resistance heating mode when the temperature of the source unit 20 becomes higher than the first threshold temperature and operates the heater 30 in the dielectric heating mode when the temperature of the source unit 20 becomes lower than the second threshold temperature that is lower than the first threshold temperature.

The processor 170 determines the resonance frequency, at which the power of the reflected electromagnetic waves is minimized in the dielectric heating mode, and when the resonance frequency is greater than a threshold value, the processor 170 operates the heater 30 in the resistance heating mode.

When the value, which is obtained by dividing the amount of power of the RF signal transmitted from the source unit 20 to the radiating unit by the amount of power provided to the source unit 20, is less than the threshold value, the processor 170 operates the heater 30 in the resistance heating mode.

When the value, which is obtained by dividing the power of the electromagnetic wave by the power of the RF signal, is less than the threshold value in the dielectric heating mode, the processor 170 operates the heater 30 in the resistance heating mode.

Some embodiments or other embodiments of the disclosure described above are not exclusive or distinct from each other. In some embodiments or other embodiments of the disclosure described above, respective components or functions may be used in combination with one another or combined with one another.

For example, a component A described in a particular embodiment and/or drawing and a component B described in another embodiment and/or drawing may be combined with each other. In other words, even when coupling between components is not directly described, the coupling may be made except when the coupling is described as impossible.

The above description should not be construed as being limited in all respects but should be considered illustrative. The scope of the disclosure should be determined by the logical interpretation of appended claims, and all changes within the equivalent scope of the disclosure are included in the scope of the disclosure.

According to the one or more embodiments, a heater of an aerosol generating device may operate selectively in a dielectric heating mode or a resistance heating mode.

The effects of the embodiments are not limited to the above-described description, and other effects may be clearly understood by one of ordinary skill in the art from the embodiments to be described hereinafter.

What is claimed is:

1. An aerosol generating device comprising:
an insertion space into which at least a portion of an aerosol generating article is inserted;
a source unit configured to generate a radio frequency (RF) signal;
a power converter configured to generate direct current of various levels;
a heater configured to heat the aerosol generating article; and
a processor,
wherein the processor is configured to:
control the power converter and the source unit to operate the heater in a dielectric heating mode in which electromagnetic waves are radiated into the insertion space or a resistance heating mode in which thermal energy is transmitted to the insertion space; and
to provide the RF signal or the direct current to the heater.

2. The aerosol generating device of claim 1, wherein the heater is formed by rolling a metal pattern with repeated “S” or “ [symbol] ” shapes into a cylindrical form.

3. The aerosol generating device of claim 1, wherein the heater comprises at least one of a nickel-iron alloy and a constantan alloy.

4. The aerosol generating device of claim 1, wherein the processor is further configured to control the power converter to apply a direct current to the heater in the resistance heating mode.

5. The aerosol generating device of claim 4, wherein the heater operates as a closed circuit.

6. The aerosol generating device of claim 1, wherein the processor is further configured to control the source unit to apply the RF signal to the heater in the dielectric heating mode.

7. The aerosol generating device of claim 6, wherein, the heater operates as an antenna that is an open-type circuit.

8. The aerosol generating device of claim 1, wherein the processor is further configured to operate the heater in the dielectric heating mode in a preheating section.

9. The aerosol generating device of claim 1, wherein the processor is further configured to:
operate the heater in the resistance heating mode in a first section of a smoking section; and
operate the heater in the dielectric heating mode in a second section after the first section.

10. The aerosol generating device of claim 1, further comprising a temperature sensing circuit arranged adjacent to the source unit and configured to measure a temperature of the source unit,
wherein the processor is further configured to:
operate the heater in the resistance heating mode when a temperature of the source unit becomes higher than a first threshold temperature; and
operate the heater in the dielectric heating mode when the temperature of the source unit becomes lower than a second threshold temperature that is lower than the first threshold temperature.

11. The aerosol generating device of claim 1, wherein the processor is further configured to:
determine a resonance frequency at which power of reflected electromagnetic waves is minimized in the dielectric heating mode; and
when the resonance frequency is greater than a threshold value, the heater operates in the resistance heating mode.

12. The aerosol generating device of claim 1, further comprising a radiating unit configured to radiate, in the form of an electromagnetic wave, the RF signal into the insertion space,
wherein the processor is further configured to, when a value obtained by dividing an amount of power of the RF signal transmitted from the source unit to the radiating unit by an amount of power supplied to the source unit is less than a threshold value, operate the heater in the resistance heating mode.

13. The aerosol generating device of claim 1, wherein the processor is further configured to, when a value obtained by dividing power of the electromagnetic wave by power of the RF signal is less than a threshold value, operate the heater in the resistance heating mode.
